(19) United States
(12) Patent Application Publication
(10) Pub. No.: US 2012/0274880 A1
(43) Pub. Date: Nov. 1, 2012

(54) METHOD FOR REDUCING SCREEN BENDING

(75) Inventor: MING-YEN LIN, Taipei City (TW)

(73) Assignee: UNIQUE INSTRUMENTS CO.LTD, Taipei City (TW)

(21) Appl. No.: 13/426,885

(22) Filed: Mar. 22, 2012

(30) Foreign Application Priority Data
Apr. 29, 2011 (TW) 100115096

(51) Int. Cl. G02F 1/1333

(52) U.S. Cl. 349/84

(57) ABSTRACT

A method for reducing screen bending is mainly applied for a conventional large-size goggle free 3D image display device, in which an improved method of laminated fixation is proposed for a screen bending defect that occurs as the screen size increases, so as to reduce cross-talk caused by screen bending, thereby achieving an objective of displaying optimum 3D images.

### BACKGROUND OF THE INVENTION

1. Field of Invention

The present invention relates to a method for reducing screen bending mainly applied for a conventional device of goggle free 3D image display with large screen size, in which an improved method of laminated fixation is proposed for a screen bending defect that occurs as the screen size increases, so as to reduce cross-talk caused by screen bending, thereby achieving an objective of displaying optimum 3D images.

2. Related Art

FIG. 1 is a schematic view of basic construction of a conventional goggle free 3D liquid crystal (LC) display. Generally a goggle free 3D LC display 1 is mainly formed of a view separation device 100, an LCD cell 200, and an LC module (LCM) 300. The view separation device 100 may be a device such as a common parallax barrier or a lenticular lens array, which has a geometric feature of a planar structure. The LCD cell 200 is an LCD cell mainly formed of a color filter substrate (not shown), a liquid crystal molecular layer (not shown), and a thin-film transistor (TFT) substrate (not shown), which also has a geometric feature of a planar structure. The LCM 300 is mainly formed of devices such as a control circuit board, a backlight module, and a mechanical frame (not shown). In addition, the view separation device 100 may also be a fixed view separation device and an LC view separation device. The so-called fixed view separation device refers to a fixed parallax barrier device and a fixed lenticular lens array device, which does not have a 2D/3D switching function. The so-called LC view separation device is an LC parallax barrier and an LC lenticular lens array capable of 2D/3D switching fabricated through an LCD cell process.

In addition, a device installation state between the view separation device 100 and the LCD cell 200 as shown in FIG. 1 presents an ideal assembly state. The so-called ideal assembly state refers to that the geometric structures of both the view separation device 100 and the LCD cell 200 are in a planar state without bending, and the two planar structures are in a planar parallel state. A vertical strip parallax barrier is taken as an example below for illustrating a corresponding relation between the vertical strip parallax barrier and a view in an ideal state.

FIG. 2 is a schematic 3D view of a corresponding relation between an aperture of a vertical strip parallax barrier and a view in an ideal state. Generally the vertical strip parallax barrier 100 is mainly formed of a plurality of vertical strip aperture components 111 and vertical strip opaque components 112, which are disposed on the LCD cell 200 with a distance of L_{B}. For the eyes of a viewer at an optimum viewing point P₀ (P₀ is located at an optimum viewing distance of Z₀), through the vertical strip aperture component 111, a view image 201 without cross-talk corresponding to the apertures may be viewed. The so-called “without cross-talk” refers to that at the position P₀, through the aperture of the vertical strip aperture component 111, the corresponding view image 201 may be viewed, but adjacent view images 202 and 203 may not be perceived.

FIG. 3 is a schematic analytical view of a corresponding relation between an aperture of a vertical strip parallax barrier and a view in an ideal state. First, a coordinate system is defined, an X axis thereof is disposed at a plane of the color filter, and the direction of the X axis is in parallel to a horizontal black matrix (BM) (not shown); a Z axis thereof is vertical to the LCD cell 200, and passes through the optimum viewing point P₀. Therefore, a right end of the vertical strip aperture component 111 is located at (B₊, L_{B}), and a left end is located at (B₋, L_{B}), while a right end and a left end of the view image 201 viewed through the aperture component 111 are individually located at (P₊, 0), (P₋, 0), which have the following relations:

$$\begin{matrix}P = {P}_{+} - {P}_{-} & ( 1 ) \\ B = {B}_{+} - {B}_{-} & ( 2 ) \\ \frac{{B}_{+}}{{P}_{+}} = \frac{{Z}_{0} - {L}_{B}}{{Z}_{0}} & ( 3 ) \\ \frac{{B}_{-}}{{P}_{-}} = \frac{{Z}_{0} - {L}_{B}}{{Z}_{0}} & ( 4 )\end{matrix}$$

In addition, the basic optics theory and analysis related to the parallax barrier may refer to ROC Patent Application No. 098128986, 099107311, and 099134699, which are no longer described in the present invention. Hereinafter, only the parallax barrier bending is taken as an example for illustrating a corresponding relation between a vertical strip parallax barrier and a view in a bending state.

FIG. 4 is a schematic 3D view of a corresponding relation between an aperture of a vertical strip parallax barrier and a view in a bending state. Compared with the LCD cell 200 in a planar state, slight bending occurs to the vertical strip parallax barrier 100 due to the influences of an external force (not shown). The external force may result from a residual stress during cutting and splinter of the LCD cell (it is assumed that the parallax barrier is the LC parallax barrier), extrusion of the mechanical frame, and gravity. Therefore, slight deformation occurs to the structure of the vertical strip parallax barrier 100. Hereinafter, a relation between a deformation amount and cross-talk is analyzed through derivation of mathematical formulas.

FIG. 5 is a schematic analytical view of a corresponding relation between an aperture of a vertical strip parallax barrier and a view when a bending amount ΔL_{B}>0. An external force is made to cause partial slight deformation to the vertical strip aperture component 111, and it is assumed that a slight displacement ΔL_{B} (hereinafter referred to as a bending amount in short) is generated in the direction of the Z axis at a disposing position of the vertical strip aperture component 111. When a value of the bending amount ΔL_{B} is positive, it represents that the deformation is convex; while when the value is negative, the deformation is concave. In the following, a relation between a bending amount and cross-talk is illustrated only through the convex deformation. For the partially bended vertical strip aperture component 111, due to changes of a position of the aperture (changing from a position 111 to a position 111′), a view image viewed through the aperture also changes. That is, the positions of the right end and the left end of the vertical strip aperture component 111 are changed into (P₊, L_{B}+ΔL_{B}), and the left end is located at (B₋, L_{B}+ΔL_{B}), the right end and the left end of the view image viewed through the aperture are individually changed into (P₊+ΔP₊, 0) and (P₋+ΔP₋, 0), and the following relations exist:

$$\begin{matrix}\frac{{B}_{+}}{{P}_{+} + Δ {P}_{+}} = \frac{{Z}_{0} - ( {L}_{B} + Δ {L}_{B} )}{{Z}_{0}} & ( 5 ) \\ \frac{{B}_{-}}{{P}_{-} + Δ {P}_{-}} = \frac{{Z}_{0} - ( {L}_{B} + Δ {L}_{B} )}{{Z}_{0}} & ( 6 )\end{matrix}$$

According to Formulas (3) and (5), following ΔP₊ can be obtained.

$$Δ {P}_{+} • \frac{P}{B} \frac{{P}_{+}}{{Z}_{0}} Δ {L}_{B} \qquad ( 7 )$$

As shown in FIG. 5, when a bending amount is ΔL_{B}>0, the deformation is convex, and a cross-talk amount ΔP₊ is a positive value, that is, an amount that a right adjacent view 202 may be perceived, and according to Formula (7), ΔP₊ is directly proportional to the bending amount ΔL_{B} and P₊, and inversely proportional to Z₀, but is unrelated to a P/B value (as a difference between P and B is usually lower than 1%).

In addition, according to Formulas (4) and (6), following ΔP₋ can be obtained.

$$Δ {P}_{-} • \frac{P}{B} \frac{{P}_{-}}{{Z}_{0}} Δ {L}_{B} \qquad ( 8 )$$

FIG. 6 is a schematic analytical view of a corresponding relation between an aperture of a vertical strip parallax barrier and a view when a bending amount ΔL_{B}<0. When the bending amount ΔL_{B}<0, the deformation is concave, and the cross-talk amount ΔP₋ is a negative value, that is, an amount that the left adjacent view 203 may be perceived, and according to Formula (8), ΔP₋ is directly proportional to the bending amount ΔL_{B} and P₋, and is inversely proportional to Z₀, but is unrelated to a P/B value (as a difference between P and B is usually lower than 1%).

FIG. 7 is a graph of a dependence relation of the cross-talk amount ΔP₊ on the parameters Z₀, P₊, and ΔL_{B}. As shown in FIG. 7, simulated calculation of actual data, making P/B=1.0073, and according to Formula (7) for common specifications of an ordinary home television: for example, the screen size=42″, a screen width=930.24 mm, and a single pixel width=0.4845 mm. ΔP₊(Z₀) represents a relation between ΔP₊ and Z₀ when P₊=465.12 mm and ΔL_{B}=0.1 mm; ΔP₊(ΔL_{B})₁ represents a relation between ΔP₊ and ΔL_{B} when P₊465.12 mm and Z₀=2000 mm; ΔP₊(P₊) represents a relation between ΔP₊ and P₊ when Z₀=2000 mm and ΔL_{B}=0.1 mm; and ΔP₊(ΔL_{B})₂ represents a relation between ΔP₊ and ΔL_{B} when P₊=1860.48 mm and Z₀=2000 mm. In addition, a cross-talk rate ΔP₊/P is defined to represent an increased percentage of cross-talk caused by the bending amount. According to a result of the simulated calculation ΔP₊(ΔL_{B})₂, for a viewer at Z₀=2000 mm, at a rightmost end of the 42″ screen, when a viewing position of the viewer deviates two screen widths to the left (that is, P₊=1860.48 mm), a slight bending amount (that is, ΔL_{B}=0.01 mm=10 μm) results in cross-talk (ΔP₊/P=1.93%). In addition, the following viewing angles are defined:

$$\begin{matrix}tan ( {θ}_{+} ) = \frac{{P}_{+}}{{Z}_{0}} & ( 9 ) \\ tan ( {θ}_{-} ) = \frac{{P}_{-}}{{Z}_{0}} & ( 10 )\end{matrix}$$

Formulas (7) and (8) may be represented as follows:

$$\begin{matrix}Δ {P}_{+} • \frac{P}{ B} Δ {L}_{B} tan ( {θ}_{+} ) & ( 11 ) \\ Δ {P}_{-} • \frac{P}{B} Δ {L}_{B} tan ( {θ}_{-} ) & ( 12 )\end{matrix}$$

Formulas (11) and (12) clearly show that the cross-talk amount is also directly proportional to a tangent value of the viewing angle. For the ΔP₊(ΔL_{B})₂, when the viewing angle is θ₊=tan⁻¹(1860.48/2000)=42.9°, that is, for large viewing angle, the slight bending amount (that is, ΔL_{B}=0.01 mm=10 μm) results in cross-talk (ΔP₊/P=1.93%).

In conclusion, for the display of the large-size goggle free 3D image, the indispensable key technology of the display of the large-size goggle free 3D image is to solve the screen bending defect.

### SUMMARY OF THE INVENTION

For the above defect, the present invention is directed to a method for reducing screen bending mainly applied for a conventional device of goggle free 3D image display with large screen size, in which an improved method of laminated fixation is proposed for a screen bending defect that occurs as the screen size increases, so as to reduce cross-talk caused by screen bending, thereby achieving an objective of displaying optimum 3D images. The so-called method of laminated fixation mainly adopts a transparent substrate with a high surface flatness, in which a view separation device and an LCD cell are laminated and fixed in a sandwich-like laminated manner, thereby achieving an objective of reducing screen bending.

### BRIEF DESCRIPTION OF THE DRAWINGS

The present invention will become more fully understood from the detailed description given herein below for illustration only, and thus are not limitative of the present invention, and wherein:

FIG. 1 is a schematic view of basic construction of a conventional goggle free 3D LC display;

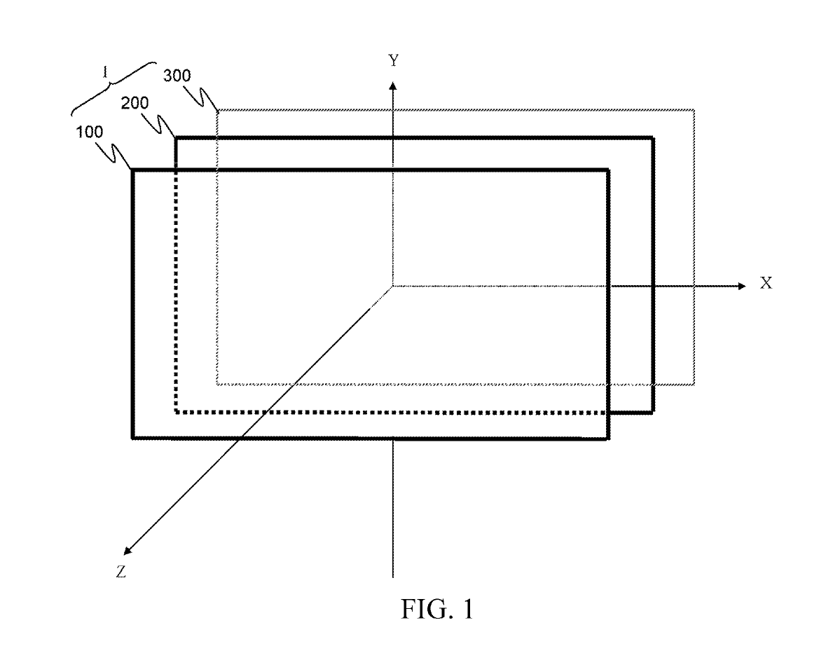

FIG. 2 is a schematic 3D view of a corresponding relation between an aperture of a vertical strip parallax barrier and a view in an ideal state;

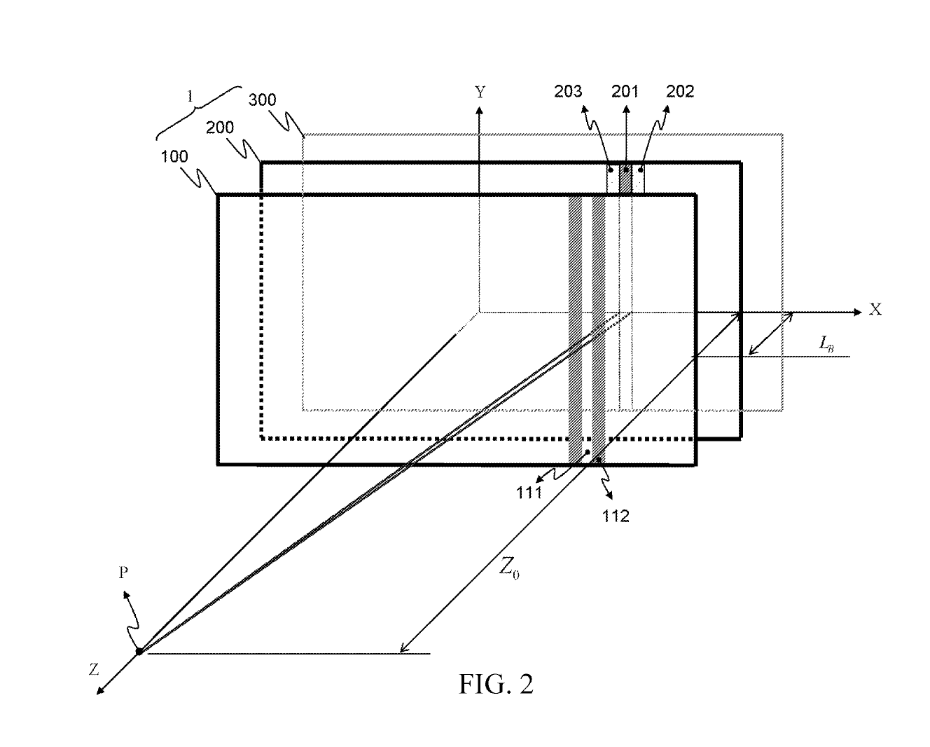

FIG. 3 is a schematic analytical view of a corresponding relation between an aperture of a vertical strip parallax barrier and a view in an ideal state;

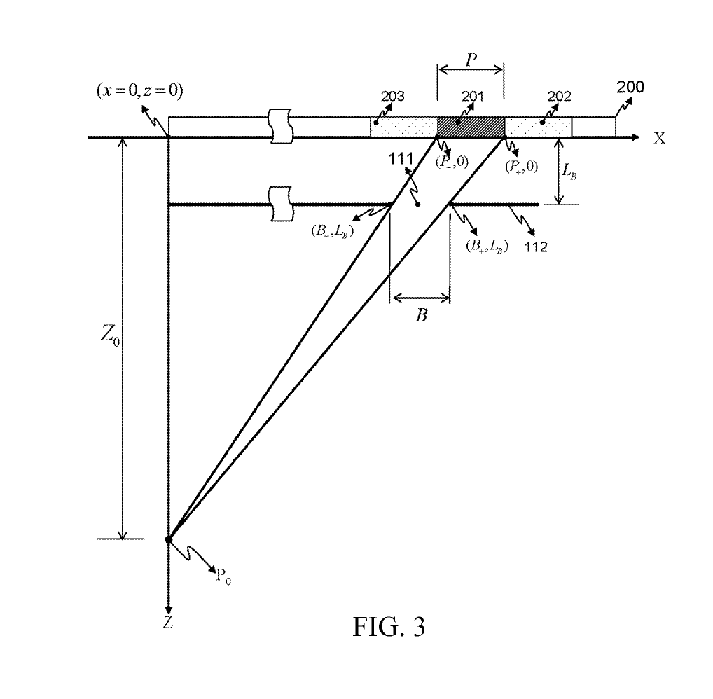

FIG. 4 is a schematic 3D view of a corresponding relation between an aperture of a vertical strip parallax barrier and a view in a bending state;

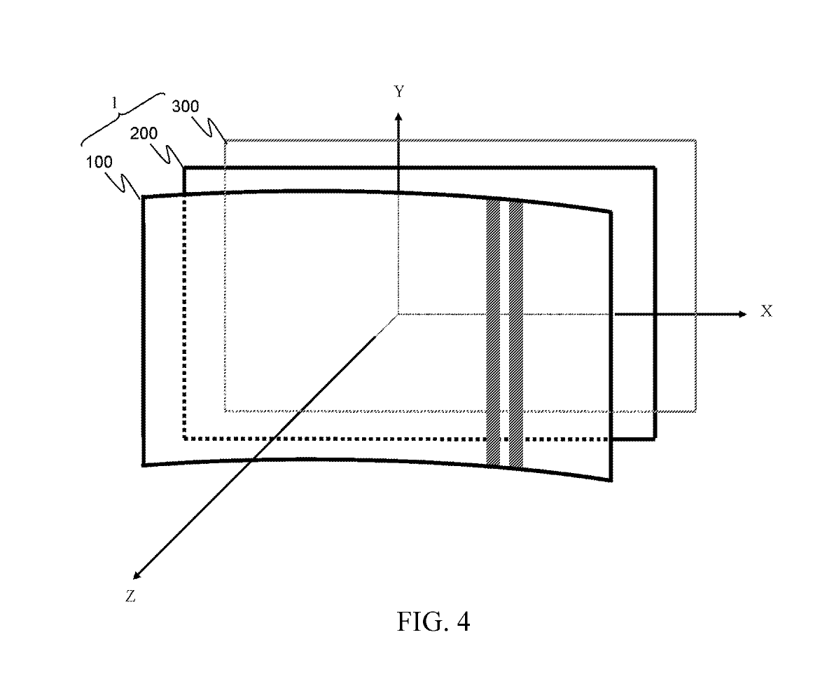

FIG. 5 is a schematic analytical view of a corresponding relation between an aperture of a vertical strip parallax barrier and a view when the bending amount ΔL_{B}>0;

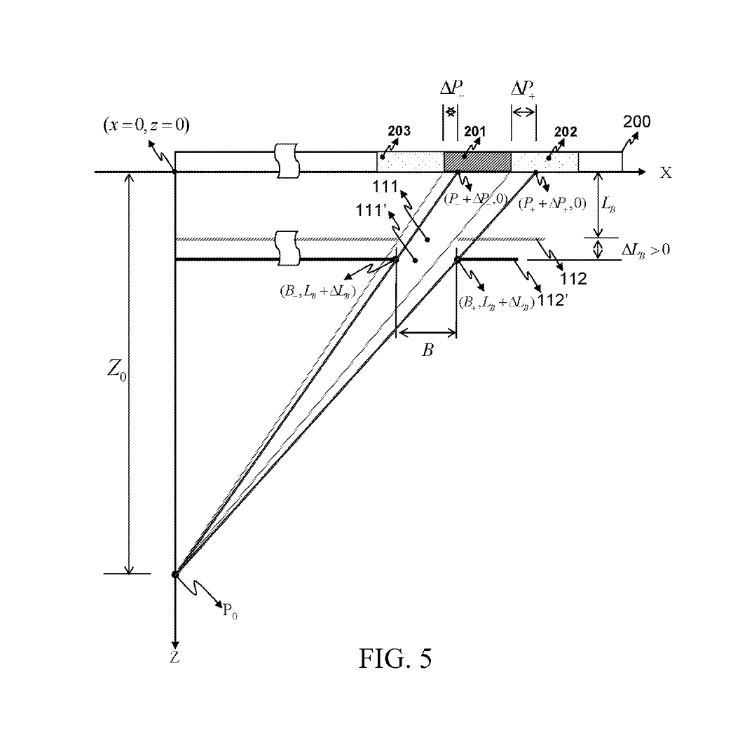

FIG. 6 is a schematic analytical view of a corresponding relation between an aperture of a vertical strip parallax barrier and a view when the bending amount ΔL_{B}<0;

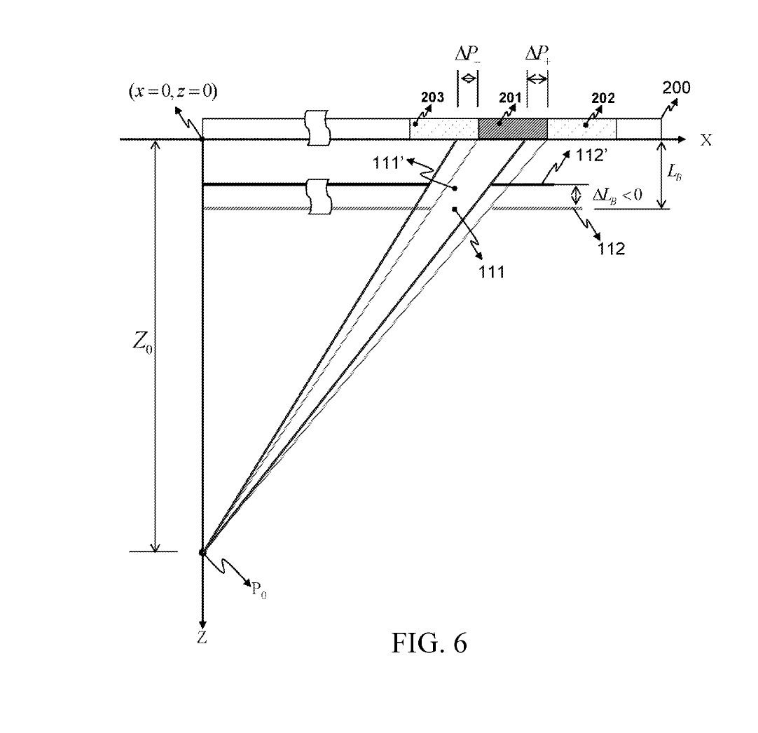

FIG. 7 is a graph of a dependence relation of a cross-talk amount ΔP₊ on the parameters Z₀, P₊, and ΔL_{B};

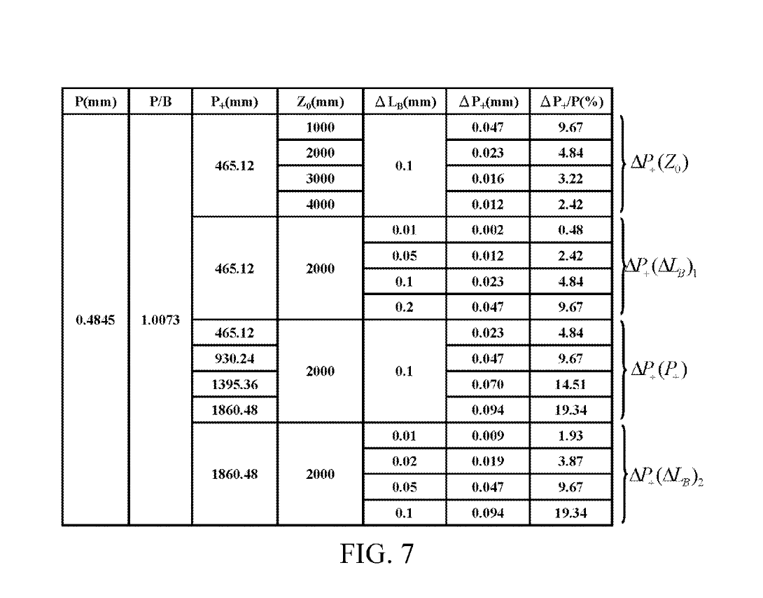

FIG. 8 is a schematic view according to a first embodiment of the present invention;

FIG. 9 is a schematic view according to a second embodiment of the present invention;

FIG. 10 is a schematic view according to a third embodiment of the present invention;

FIG. 11 is a schematic view according to a fourth embodiment of the present invention; and

FIG. 12 is a schematic view according to a fifth embodiment of the present invention.

### DETAILED DESCRIPTION OF THE INVENTION

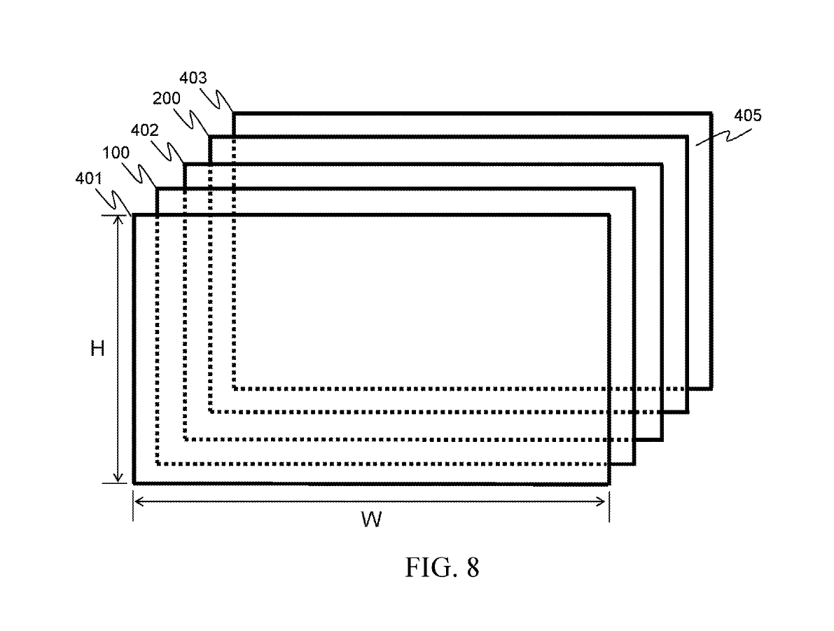

FIG. 8 is a schematic view according to a first embodiment of the present invention. A view separation device 100 and an LCD cell 200 are laminated by three transparent substrates with a high surface flatness 401, 402, and 403 in a sequence of the transparent substrate 401, the view separation device 100, the transparent substrate 402, the LCD cell 200, and the transparent substrate 403. The transparent substrates 401, 402, and 403 are made of glass, an area (W×H) thereof can be the same as an area of the view separation device 100 or the LCD cell 200, and the flatness in a long-side direction and a short-side direction is smaller than 10 um/W and 10 um/H (for ease of illustration, the definition of flatness below is the maximum height difference in the total length as a unit, that is, only the value of the maximum height difference is illustrated for the value of the flatness). In addition, for a gap between the laminated layers (only one gap is shown), a highly light-transmissive fixation material 405, for example, liquid optically clear adhesive, may be adopted to fill the gap between the laminated layers, thereby achieving the objectives of fixation and light guiding.

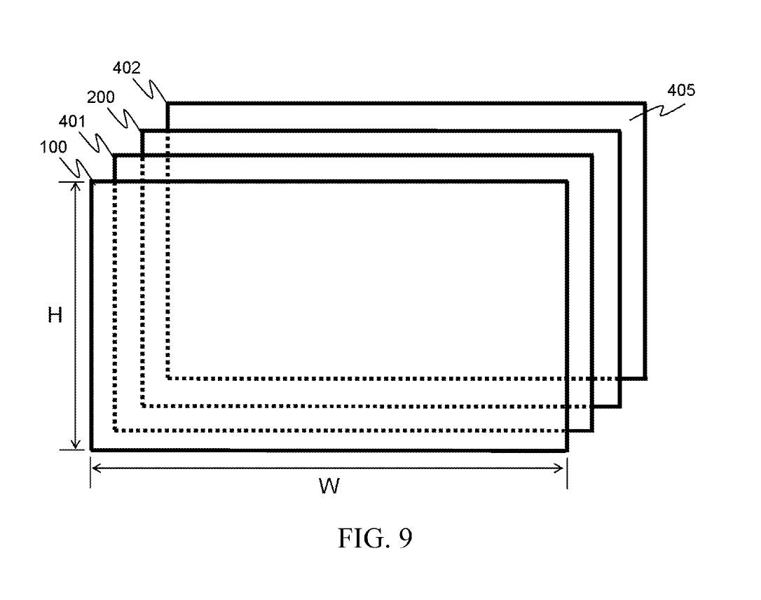

FIG. 9 is a schematic view according to a second embodiment of the present invention. The view separation device 100 and the LCD cell 200 are laminated and fixed by two transparent substrates with a high surface flatness 401 and 402 as discussed above in a sequence of the view separation device 100, the transparent substrate 401, the LCD cell 200, and the transparent substrate 402 as described in the first embodiment.

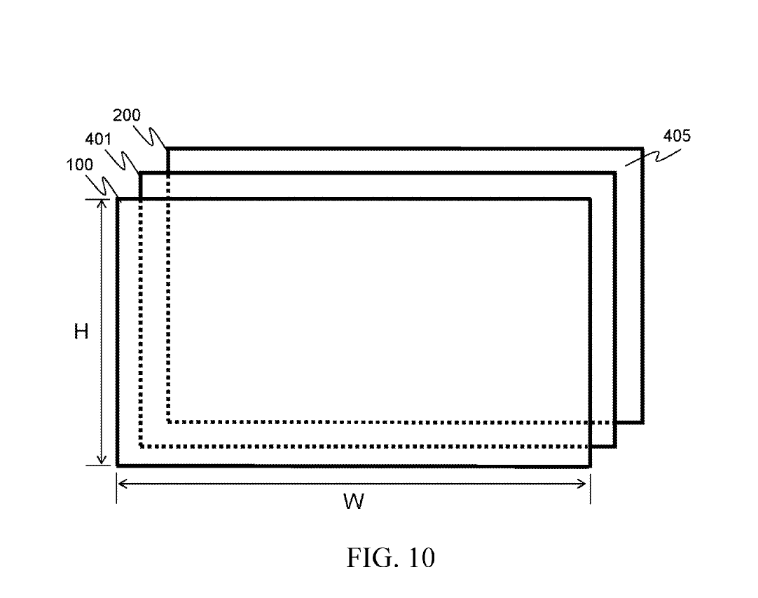

FIG. 10 is a schematic view according to a third embodiment of the present invention. The view separation device 100 and the LCD cell 200 are laminated and fixed by one transparent substrate with a high surface flatness 401 as discussed above in a sequence of the view separation device 100, the transparent substrate 401, and the LCD cell 200 as described in the first embodiment.

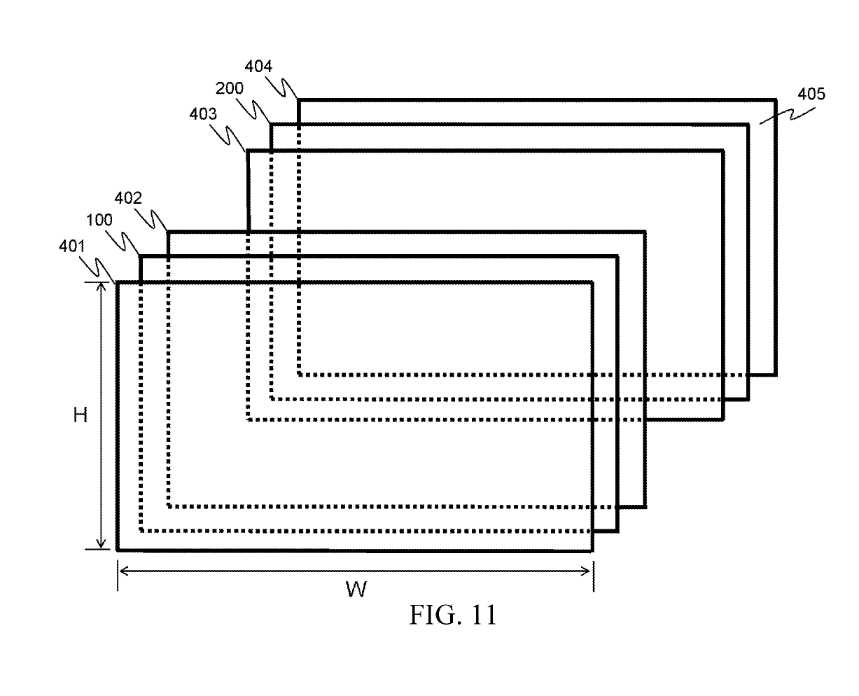

FIG. 11 is a schematic view according to a fourth embodiment of the present invention. The view separation device 100 and the LCD cell 200 are respectively laminated and fixed by two transparent substrates with a high surface flatness 401, 402, 403, and 404 as discussed above in the first embodiment. That is, the view separation device 100 is laminated and fixed by the transparent substrates 401 and 402, while the LCD cell 200 is laminated and fixed by the transparent substrates 403 and 404.

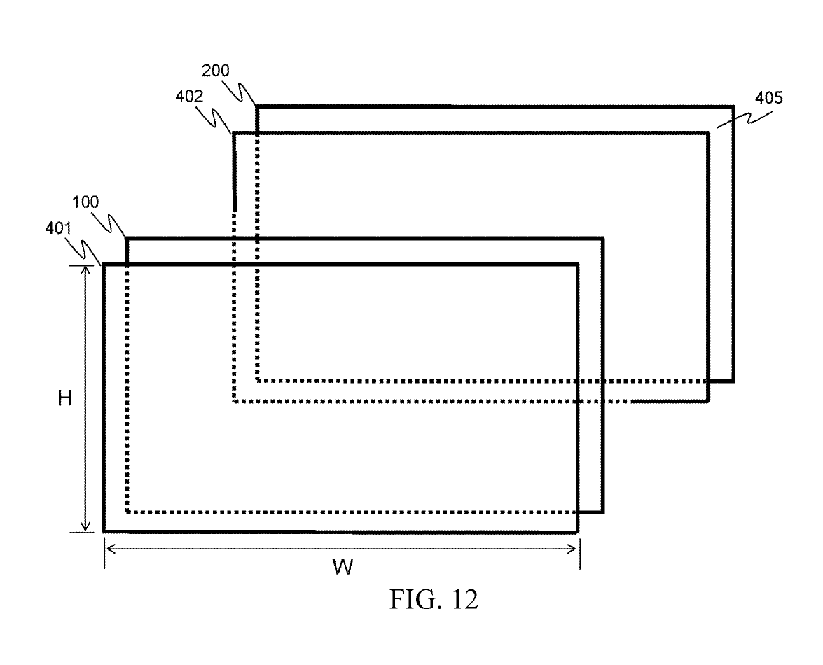

FIG. 12 is a schematic view according to a fifth embodiment of the present invention. The view separation device 100 and the LCD cell 200 are respectively laminated and fixed by one transparent substrate with a high surface flatness 401 and 402 as discussed above in the first embodiment. That is, the view separation device 100 is fixed by the transparent substrate 401, and the LCD cell 200 is fixed by the transparent substrate 402.

The above description is merely exemplary embodiments of the present invention, which are not intended to limit the scope of the present invention, and all equivalent changes and modifications made based on the claims of the present invention shall still fall within the scope of the claims of the present invention. Particularly, the method of laminated fixation disclosed in the present invention is also applicable to other planar displays (for example, a plasma screen and an organic light emitting diode (OLED) screen), and is also applicable to a small-size planar display. In addition, for the lamination sequence in all the embodiments, other different lamination sequences are also applicable. Thus, we will be most grateful if a patent right is granted upon careful examination of the Examiner.

What is claimed is:

1. A method for reducing screen bending, wherein an implementation device of the method for reducing screen bending is formed of a view separation device, a liquid crystal display (LCD) cell, and a plurality of transparent substrates with a high surface flatness, the view separation device, the LCD cell, and the transparent substrates are combined and fixed by using a method of laminated fixation, and in the method of laminated fixation, the view separation device and the LCD cell are laminated and fixed in a sandwich-like laminated manner by using the transparent substrates with a high surface flatness, thereby achieving an objective of reducing screen bending.

2. The method for reducing screen bending according to claim 1, wherein the plurality of transparent substrates with a high surface flatness is made of glass.

3. The method for reducing screen bending according to claim 1, wherein the plurality of transparent substrates with a high surface flatness has a flatness in a long-side direction and a short-side direction smaller than 10 um.

4. The method for reducing screen bending according to claim 1, wherein in the method of laminated fixation, the view separation device and the LCD cell are laminated by using three transparent substrates with a high surface flatness in a sequence of the transparent substrate, the view separation device, the transparent substrate, the LCD cell, and the transparent substrate.

5. The method for reducing screen bending according to claim 1, wherein in the method of laminated fixation, the view separation device and the LCD cell are laminated by using two transparent substrates with a high surface flatness in a sequence of the transparent substrate, the view separation device, the transparent substrate, and the LCD cell.

6. The method for reducing screen bending according to claim 1, wherein in the method of laminated fixation, the view separation device and the LCD cell are further laminated by using one transparent substrate with a high surface flatness in a sequence of the view separation device, the transparent substrate, and the LCD cell.

7. The method for reducing screen bending according to claim 1, wherein in the method of laminated fixation, the view separation device and the LCD cell are further respectively laminated by using two transparent substrates with a high surface flatness, that is, the view separation device is laminated in a sequence of the transparent substrate, the view separation device, and the transparent substrate, and the LCD cell is laminated in a sequence of the transparent substrate, the LCD cell, and the transparent substrate.

8. The method for reducing screen bending according to claim 1, wherein in the method of laminated fixation, the view separation device and the LCD cell are further respectively laminated by using one transparent substrate with a high surface flatness, that is, the view separation device is laminated in a sequence of the transparent substrate and the view separation device, and the LCD cell is laminated in a sequence of the transparent substrate and the LCD cell.

9. The method for reducing screen bending according to claim 1, wherein in the method of laminated fixation, gaps between laminated layers existing between the transparent substrate with a high surface flatness and the view separation device as well as the LCD cell are filled with a highly light-transmissive fixation material, so as to achieve an objective of fixation and light guiding.

10. The method for reducing screen bending according to claim 9, wherein the highly light-transmissive fixation material is liquid optically clear adhesive.

11. The method for reducing screen bending according to claim 1, wherein the view separation device is formed of a parallax barrier and a lenticular lens array.

12. The method for reducing screen bending according to claim 11, wherein the parallax barrier is formed of a fixed parallax barrier and a liquid crystal (LC) parallax barrier.

13. The method for reducing screen bending according to claim 11, wherein the lenticular lens array is formed of a fixed lenticular lens array and an LC lenticular lens array.
